(19) United States
(12) Patent Application Publication
(10) Pub. No.: US 2001/0000301 A1
(43) Pub. Date: Apr. 19, 2001

(54) Device and system for providing access to the internet

(76) Inventors: Garrison G. Zong, Houston, TX (US); Shuh C. Chang, Sugar Land, TX (US); Ivo Zinkov, Toronto (CA); Mike Min-Chu Chen, Sugar Land, TX (US)

Correspondence Address: Darcell Walker, 8107 Carvel Lane, Houston, TX, 77036, US

(21) Appl. No.: 09/728,542

(22) Filed: Dec. 1, 2000

Related U.S. Application Data
(63) Continuation-in-part of application No. 09/289,756, filed on Apr. 12, 1999.
(60) Provisional application No. 60/168,507, filed on Dec. 2, 1999.

(51) Int. Cl. G06K 1/00; G06F 15/16; G06F 13/38; H04N 1/00

(52) U.S. Cl. 358/1.15; 709/217; 709/227; 358/402

(57) ABSTRACT

The present invention is an expansion of the IFB device that provides a means to enable multiple devices to access a global computer network (such as the “Internet”) from a single network connection. The present invention comprises an input modem for communicating directly with a personal computer. This device can have a second input modem that communicates directly with a second device such as a facsimile machine. The invention has an output modem that communicates with the Internet or computing network. The present invention also contains a Central Processing Unit (“CPU”) to run various application software programs, a ROM that will store the software and a RAM that can store information sent or received over the computer network. The invention also contains software utility programs that will establish a dial-up connection with the computer network that will enable a personal computer to access the network.

### CROSS REFERENCE TO RELATED APPLICATION

1. This application is a continuation-in-part of and claims priority of from application Ser. No. 09/289,756, filed on Apr. 12, 1999, the contents of which are incorporated by reference. This application also claims priority of Provisional application no. 60/168,507 filed Dec. 2, 1999, the contents of which are also incorporated herein by reference.

### FIELD OF THE INVENTION

2. This invention relates to a device and system for accessing the Internet and in particular to a device and system for enabling multiple devices to access the Internet simultaneously over the same Internet connection.

### BACKGROUND OF THE INVENTION

3. Global computer networks such as the “Internet” have become a major and vital means of communication (Inventor will use the terms “global compute network” and “Internet” interchangeably through this entire discussion). The Internet today can facilitate the transmission of most forms of information including video, audio and text information. In addition, many different end devices can send and receive information over this network. These devices include telephones, facsimile machines and all types of computers. Although many devices can use the Internet to send and receive information, some of these devices that are non-computer devices require a means to connect them to the Internet. One such machine that falls into this category is the facsimile machine.

4. One such device that can connect a facsimile machine to a global computer network is the Internet Fax Box (IFB) described in U.S. patent application Ser. No. 09/289,756, which is incorporated herein by reference. With this device, it is not necessary to use a conventional computer in the communication stream in order to transmit information from a facsimile machine over the Internet. When the IFB is connected to a conventional fax machine, it creates a faxing system that can send and receive facsimile messages over the Internet. One can send faxes to any fax machine within an Internet free fax coverage network, to any standard e-mail based fax network, to other Internet Fax Box (IFBs) anywhere in the world, and can communicate directly with any other computer having an Internet connection.

5. The Internet Fax Box, referred to as an IFB, comprises a box containing an input modem for communicating with the facsimile machine and an output modem to communicate with the Internet or other computer network. The IFB supplies the required loop current for communication to the fax machine. This current is necessary in order for the fax modem to operate as if the present invention was also a fax machine. In this arrangement, the fax machine would transmit to and accept information from the present invention.

6. In operation, the user simply dials the destination fax number on their fax machine and the fax is delivered via the IFB and Internet to the destination in any location in the world for the cost of a local telephone call. The present invention receives incoming fax data from a fax machine directly connected to it and converts the fax image into an e-mail message. The e-mail message is routed via on the Internet to a fax server at a location near the destination fax machine by a network of servers. The message is then converted to a fax format and faxed locally to the destination fax machine. This network of servers is in existence today and covers most of the world.

7. This device is a low-cost Internet faxing device referred to hereafter as (“IFB”), that enables one to send and receive fax information using the Internet as the transmission means instead of direct point-to-point telephone communication.

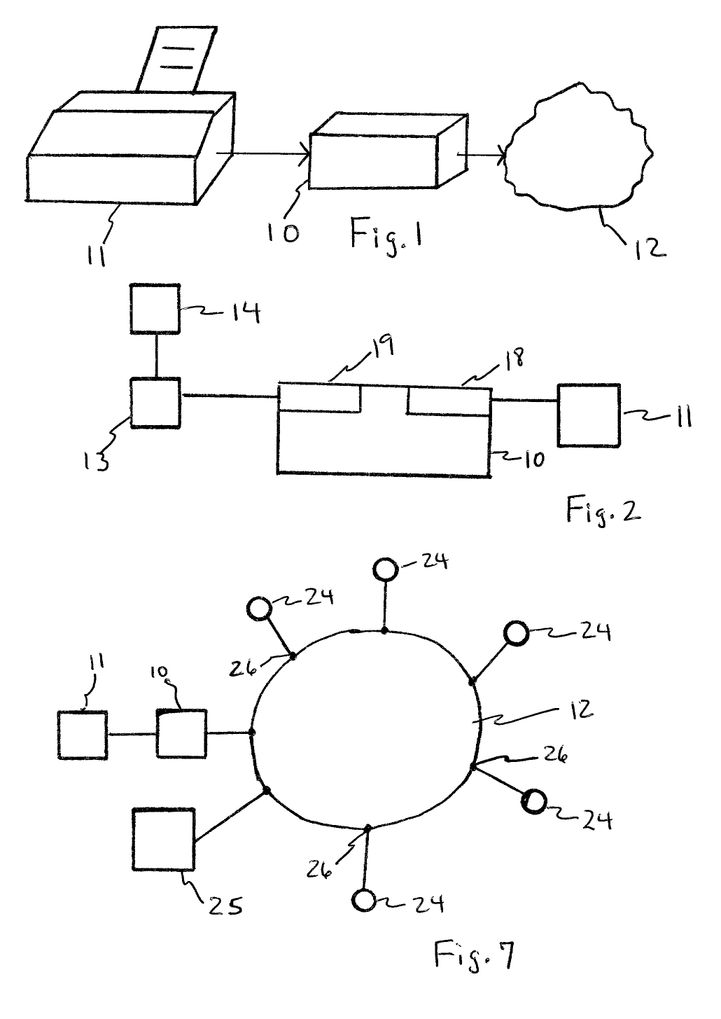

8. Referring to FIG. 1, the IFB 10 connects a facsimile machine (“fax machine”) 11 to the Internet 12. In this configuration, the fax machine sends and receives fax transmissions via the Internet through the IFB. This capability would not be available without the IFB. FIG. 2 shows the exterior of the IFB. The invention does not require any additional external hardware. FIG. 2 shows the front-end configuration of the fax machine connected to the global computer network using an IFB. As shown in FIG. 1, the fax machine 11 connects to the Public Branch Exchange (PBX) 13 through the IFB 10. This PBX is the local telephone company. The PBX connects to the Internet Service Provider (ISP) 14.

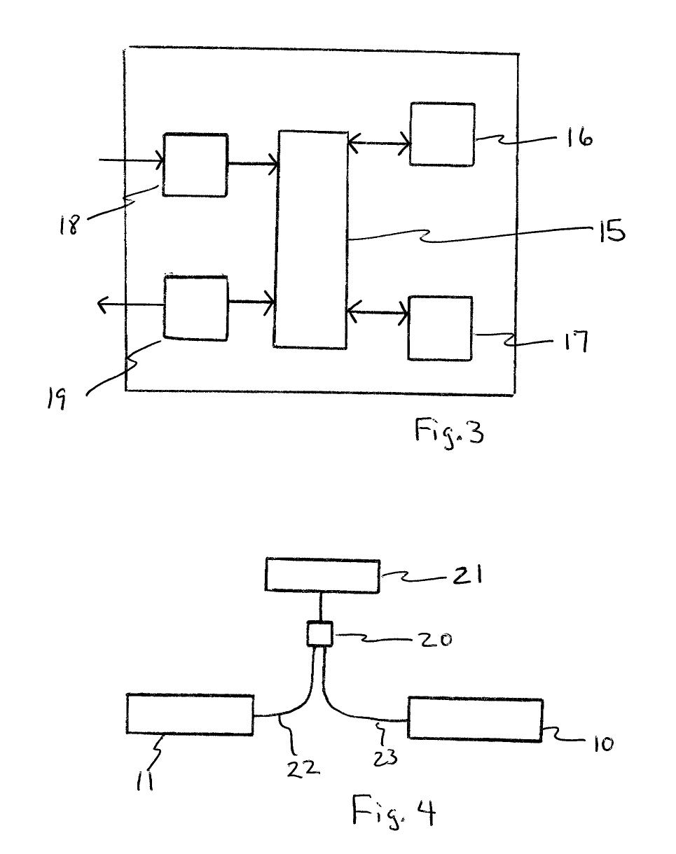

9. FIG. 3 is a block diagram of the hardware of the Internet Fax Box. The IFB 10 is basically a diskless low cost embedded PC. It can use a 386 type or above CPU 15 to run conversion, packaging and routing software. A ROM 16 will store all of the software. The RAM 17 will store fax information for transmittal to a destination fax machine or receipt from another fax machine. The software and the OS can be ROMed to reduce costs and power requirements. Two modems 18 and 19 enable the IFB to interface with the fax machine 11 and the Internet 12. The output modem 19 is a standard fax/modem. However, the input modem 18 is a modified fax/modem with a special design. This special modem can consists of an adapter 20 that draws current from the RS-232 line 21 (COM port) of the IFB and supplies it to the two middle wires of the 4-wire RJ11 cable. FIG. 4 shows the basic concept and configuration of this adapter. The adapter 23 is connected to the fax machine 11 by cable 22 and connected to the IFB 10 by cable 20. This connection can be either inside the IFB or external to the IFB. The purpose of this adapter configuration is to simulate the line voltage supplied by the telephone company, when the fax machine is connected to the RJ11 outlet (although the adapter 23 in this embodiment drawings the current from the current source, this function can be performed by other means and without an adapter). Because fax machines communicate on lines with a standard voltage, without these voltages, the fax machine would not be able to send and receive faxes to the modem in the IFB, as well as accept DTMF commands from the IFB. The polarity of the supplied current is not important, as long as the voltage is above 3.5V DC. The RS-232 supplies a clean 3V-5V at pins 4 and 5 of a 9-pins RS-232. The Internet Fax Box has been first implemented in a PC and passed all functional tests. Later, after all the functionality has been verified, the hardware will be optimized for cost by removing all the unnecessary parts and placing it in a small box. Soft modems from PCTel could be integrated into the new design

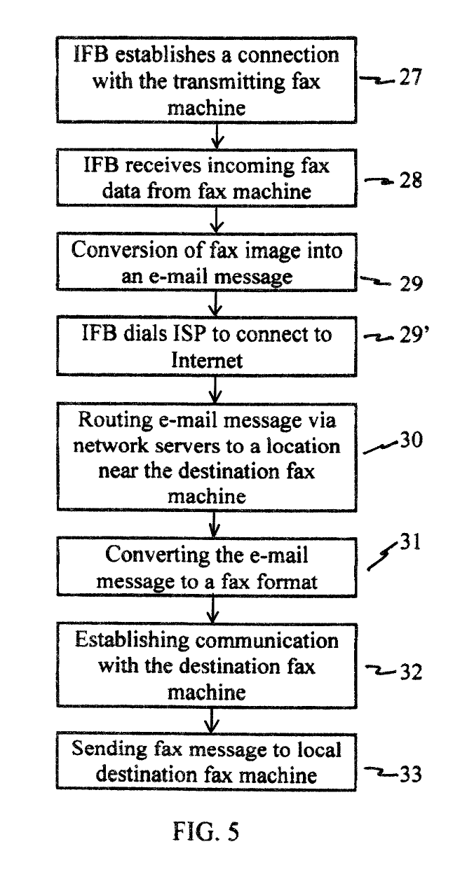

10. FIG. 5 shows the operation of transmitting fax information using the system of the present invention. At the initiation of a faxing procedure, communication is established 27 between the IFB and the transmitting fax machine. The IFB then receives the incoming fax data from a fax machine directly connected to it 28 and converts the fax image into an e-mail message 29. The IFB then dials the Internet Service Provider (ISP) 29′ to connect to the Internet. The e-mail message is routed to a location near the destination fax machine by a network of servers 30. The message is then converted to a fax format and faxed locally to the destination fax machine 31. This network of servers is in existence today and covers most of the world. One of the routing networks needed for routing the faxes is created and maintained by the Outreach group and their Remote Printing project. For more information see: http://www.faxtel.com. There are also a number of other private networks that perform similar functions. The local fax server then establishes communication with the destination fax machine 32. After establishing successful communication with the destination fax machine, the local server transmits the fax information to the destination fax machine 33. If there is no successful connection with the destination fax machine, the entire transmission fails, as is the case with current fax transmissions. The sender is informed by receiving e-mail message, which can be initiated to the IFB.

11. The procedure described in FIG. 5, gives an overview of worldwide toll free faxing in accordance with the present invention. The description of the operations of the IFB involves steps 27, 28, 29 and 29′. When the user presses the START/SEND button on the fax machine, the IFB connects the fax machine to its internal fax/modem card and signals the fax machine that it is ready to receive the incoming fax 37. Because of the adapter configuration 20 and 21 of FIG. 4, the fax machine cannot distinguish between the local and remote fax, and “thinks” that a remote fax machine has responded and precedes to send the fax.

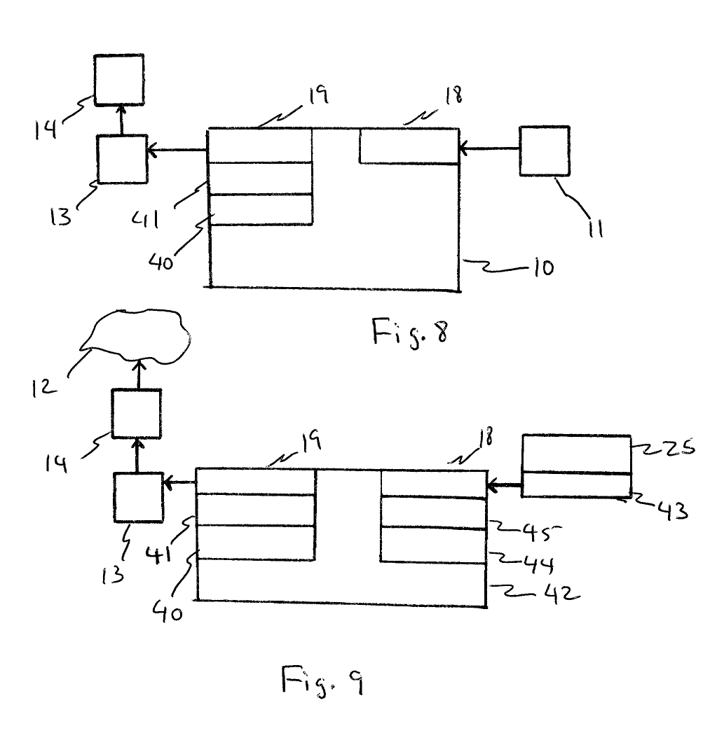

12. Although the IFB enables a user to send and receive information in facsimile form over the Internet, if the same user desires to have access to the Internet via a personal computer, the user would need to disconnect the IFB and the telephone line and connect the personal computer to that telephone line. This scenario underscores a main deficiency in Internet access devices. These access devices only allow one machine to have access to the Internet from one connection (access) point at one time. As shown in FIG. 7, different types of devices 24 can access the Internet 12. Each device has access from a separate node or connection point 26. The fax machine 11 is connected to the Internet through the IFB and a node 26. The personal computer 25 has access to the Internet through another node. Whether the accessing scheme is a time division scheme or a frequency-multiplexing scheme, no two devices share the same access point.

13. The current design of IFB uses one (using COM1) of the two modems, Modem 19, to connect to the Internet through the ISP, while the other modem (using COM2), Modem 18, is connected to the fax machine to read the fax image. FIG. 2 shows a current network access device configuration. In this configuration, the IFB is connected to the Internet through Modem 1. The fax machine connects to the IFB through Modem 18. If a user wanted to access the Internet through a second device, the fax machine would need to be disconnected from the Modem 18 and the second device connected to Modem 18. There remains a need to a device that can allow multiple devices to connect to and communicate over the Internet simultaneously.

### SUMMARY OF THE INVENTION

14. It is an objective of this invention to provide a device that will enable a facsimile machine and another device such as personal computer to access a global computer network simultaneously over the same global computer network.

15. It is another objective of this invention to enable a personal computer to share the global computer network connection with a facsimile machine through the present invention.

16. It is a third object of this invention to use only one telephone line to connect to the computer network while the facsimile machine and personal computer can access the network at the same time through that one telephone line.

17. It is a fourth objective of this invention is to establish back-to-back modem connection between the device of the present invention and the personal computer.

18. The present invention is an expansion of the IFB device that provides a means to enable multiple devices to access a global computer network (such as the “Internet”) from a single network connection. The present invention comprises an input modem for communicating directly with a personal computer. This device can have a second input modem that communicates directly with a second device such as a facsimile machine. The invention has an output modem that communicates with the Internet or computing network. The present invention also contains a Central Processing Unit (“CPU”) to run various application software programs, a ROM that will store the software and a RAM that can store information sent or received over the computer network. The invention also contains software utility programs that will establish a dial-up connection with the computer network that will enable a personal computer to access the network.

19. In operation, when the user connects a personal computer to the computer network using the present invention, the user accesses a dial-up login utility program. The user then follows normal procedures used in dial-up connections to the Internet. When using a fax machine, the user simply dials the destination fax number on their fax machine and the fax is delivered via the IFB and Internet to the destination in any location in the world for the cost of a local telephone call. The present invention receives incoming fax data from a fax machine directly connected to it and converts the fax image into an e-mail message. The e-mail message is routed via on the Internet to a fax server at a location near the destination fax machine by a network of servers. The message is then converted to a fax format and faxed locally to the destination fax machine. This network of servers is in existence today and covers most of the world. The present invention can also input and store fax information and perform the faxing operation at a later time.

### DESCRIPTION OF THE DRAWINGS

20. FIG. 1 is a configuration of a global computer network facsimile system incorporating the current Internet faxing box (IFB) device.

21. FIG. 2 is a configuration of the access of a fax machine to a global computer network using an Internet faxing box (IFB).

22. FIG. 3 is a hardware block diagram of the Internet faxing box.

23. FIG. 4 is a configuration of the connection of a fax machine to the Internet faxing box via a line voltage simulator adapter.

24. FIG. 5 is a flowchart of the steps in the fax transmission process using the IFB.

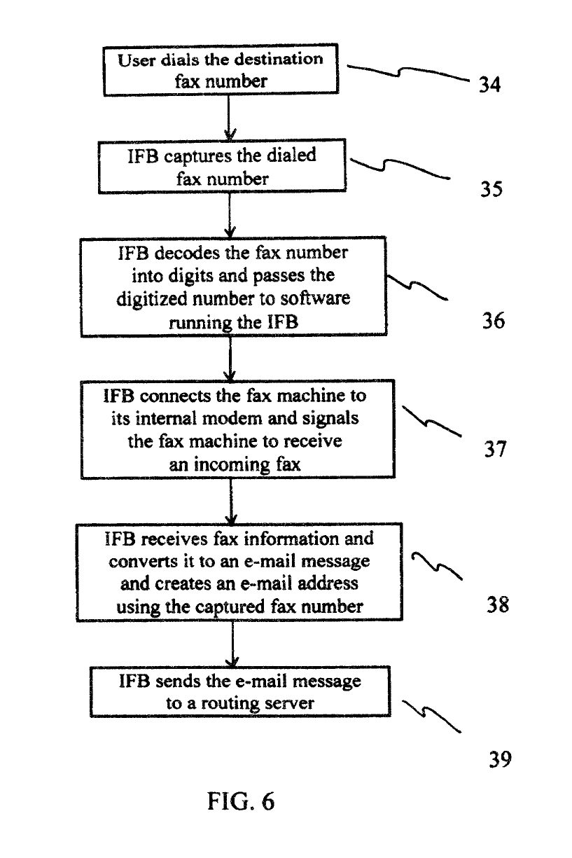

25. FIG. 6 is a flowchart of the internal steps of the IFB during the fax transmission process.

26. FIG. 7 is an overview of a computer network with different devices that access the network.

27. FIG. 8 is a detailed block diagram of the connection of a fax machine to a global computer network using an Internet faxing box.

28. FIG. 9 is a block diagram of the preferred embodiment of the present invention in a configuration for providing network access to multiple devices.

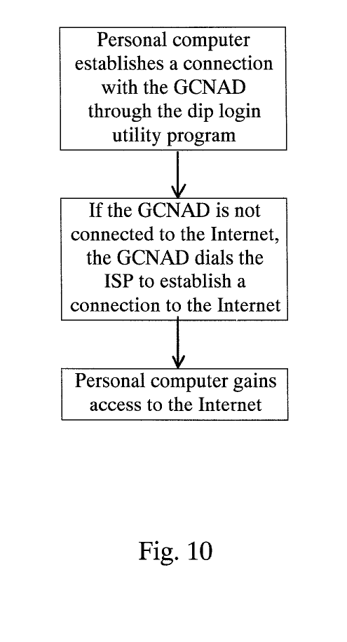

29. FIG. 10 is a flow diagram of the steps involved in the process of accessing a global computer network with the GCNAD.

30. FIG. 11 is a block diagram of an alternate embodiment of the present invention having a third modem.

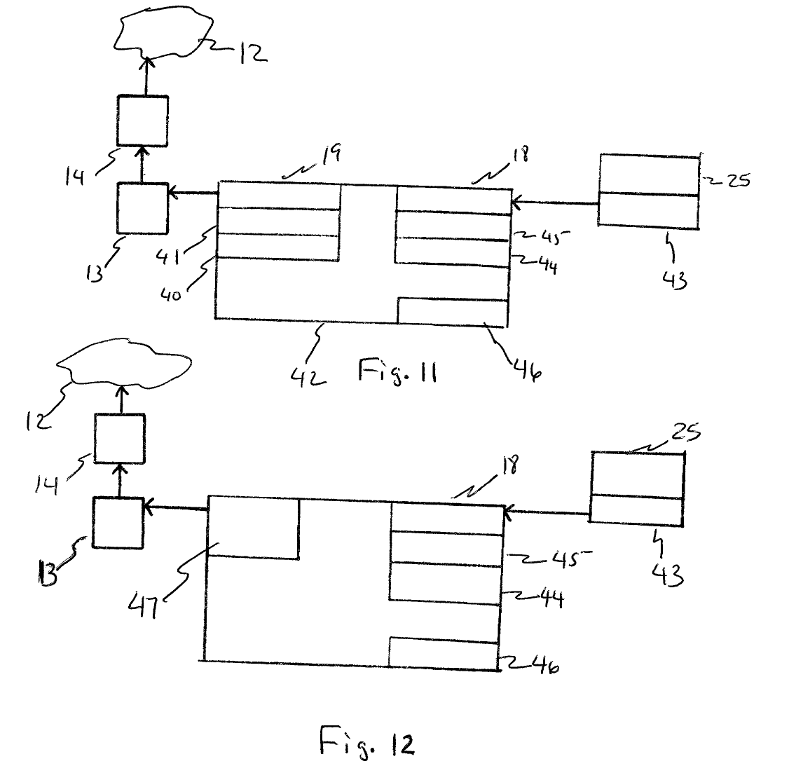

31. FIG. 12 is a block diagram of another alternate embodiment of the present invention using a Local Area Network (LAN) port instead of a dial-up protocol.

### DETAILED DESCRIPTION OF THE INVENTION

32. The concept of using a modified and expanded version of the Internet Faxing Box called the Global Computer Network Access Device (GCNAD) 42 along with a PC to “share” an Internet connection point 26, shown in FIG. 7, can be a valuable feature for the network users. In other words, while the IFB is connected to the Internet through Modem 19 using COM1, it is desired to be able to connect a PC to the IFB and let the PC share the Internet connection through the IFB. The advantage of this setup is to use only one telephone line to connect to the Internet while both the IFB and the PC can access the Internet at the same time.

33. As shown in FIG. 8, the current IFB device 10 uses a client, the “dip” utility program 40 to dial out through modem 19 to connect to the ISP 14, through the PBX 13 and therefore to the Internet 12. When the connection is made, the point-to-point protocol (ppp) connection interface, ppp0 41 is created.

34. In order to be able to share the Internet with a PC, the fax machine connected the modem 18 on the IFB as shown in FIG. 8 can be replaced with a regular PC equipped with a modem. In this configuration, there are no hardware modifications needed on the GCNAD. The link between the GCNAD 42 and the PC 25 can be achieved by a “back-to-back” modem connection. In this design, a single telephone line connects the modem 43 on the PC 25 and the modem on the GCNAD. A block diagram that illustrates this setup is shown in FIG. 9.

35. This embodiment of the present invention has two modems 18 and 19. Modem 19 connects the GCNAD device to the Internet 12. Modem 18 connects to the external device such as a personal computer 25 or a facsimile machine 11 to the GCNAD 42. As with the IFB, the GCNAD uses a client, the “dip” utility program 40, to dial out to a private branch exchange (PBX) 13 through modem 19 to connect the GCNAD 42 to the ISP 14 and therefore to the Internet 12. This “dip” program can be the one currently used in the IFB. As previously mentioned, when the connection is made, a point-to-point protocol (ppp) connection interface, ppp0, is created. When this connection occurs, the modem 18 can now be used for receiving a dial-in connection from the personal computer 25.

36. A server, “dip login” utility program 44 in this invention, can now be used in the GCNAD to accept the dial-in connection from the PC. Once the dial-in connection is made, the ppp connection interface, ppp1 45, should have been created as shown in FIG. 9. The Dip login 44 is the new server program that needs to be added to the GCNAD 42. Of course, the GCNAD shell script programs would also need to be modified to take advantage of this new configuration.

37. Once the hardware and software for this new feature are set up, there would require some configuration on the IFB side, i.e. for the dip login server. The ideal configuration would be an IFB account that can accept the PC user to dial in, probably also requiring some sort of authentication based on PAP protocol or just a login protocol. This pair of login ID and login password is different from that of normal system console login using tools like telnet or ftp.

38. To simplify the configuration process for the GCNAD dial-in/login connection, one can probably just provide a fixed pair of login ID and password. However, if there warrants a need for multiple user ID's and passwords, we can reserve the provision for that feature also.

39. FIG. 10 illustrates the steps involved in using the GCNAD. In the first step, the personal computer establishes a connection with the GCNAD device through modems 43 and 18 and the dip login utility program 44. Because the GCNAD had the capability to send and receive information in the form of facsimile messages, the GCNAD may already have a connection to the Internet at this point. If this were the case, the personal computer would have access to the internet once it establishes a connection with the GCNAD. If there is not a current connection, the GCNAD will initiate the dip program 40 and establish an Internet connection through the PBX and ISP.

40. An alternate embodiment of the present invention is shown in FIG. 11. This embodiment shows a fourth modem 46 used to enable a device such as a facsimile machine to connect to the Internet through the present invention simultaneously with the PC. As previously described, the present embodiment of the invention, enabled the IFB to share the same internet connection with the PC and to be able to send information over the internet, while the PC was also connected to the internet through the same connection point. Software used in the IFB device could be used to facilitate communication of the facsimile machine via the Internet. With this embodiment, the third modem could be dedicated to the facsimile machine via the GCNAD. This embodiment would not change any personal computer procedures previously discussed.

41. A third embodiment of the present invention uses a local area network (LAN) port 47 instead of the modem 1, ppp0 and dip configuration shown in FIG. 12. The LAN port uses a T1 connection and broadband communication technology to connect to a Public Switched Telecom Network (PSTN). With the LAN port, there would be a continuous connection between the GCNAD and the Internet. The facsimile machine or the PC could communicate with the Internet as needed independent of the other device. This LAN protocol would replace the ppp0 dip protocol required to connect the GCNAD to the ISP. In addition, this embodiment could also incorporate the fourth modem 46 as shown in FIG. 12.

42. The methods of this invention provide significant advantages over the current art. The invention has been described in connection with its preferred embodiments. However, it is not limited thereto. Changes, variations and modifications to the basic design may be made without departing from the inventive concepts in this invention. In addition, these changes, variations and modifications would be obvious to those skilled in the art having the benefit of the foregoing teachings. All such changes, variations and modifications are intended to be within the scope of this invention, which is limited only by the following claims.

We claim:

1. A computer network access system for establishing access for multiple devices simultaneously and from one access point comprising:
a. at least two devices capable of sending, receiving or accessing data;
b. a computer access device (GCNAD) connected to said remote data devices, said GCNAD capable of connecting said data devices to the computer network, the computer network accessing software for establishing the connection between the GCNAD and the computer network; and computer network accessing software for establishing the connection between the GCNAD and the data devices.

2. The system of claim 1 wherein said GCNAD comprises:
a first input modem for connecting said GCNAD with a said remote data device;
an output modem for connecting to and establishing communication with the computer network; and
a central processing unit for executing said accessing software.

3. The system of claim 2 wherein said accessing software for establishing the connection between the GCNAD the global computer network comprises a dip utility program to dial out through said output modem to connect to an Internet Service Provider.

4. The system of claim 1 wherein said remote data devices comprise a personal computer and a facsimile machine.

5. The system of claim 4 wherein said accessing software in said GCNAD comprises a dip login server program to enable a remote personal computer device to dial-up the GCNAD and establish communication with the GCNAD.

6. The system of claim 2 wherein said GCNAD further comprises a second input modem for providing communication with a said remote data device.

7. A computer network access device for establishing access for multiple devices simultaneously from one access point comprising:
a) a first input modem for connecting said access device with a remote data device;
b) an output modem for connecting said access device with the global computer network;
c) software for establishing communication between said access device and the global computer network and said access device and a remote data device; and
d) a central processing unit for executing said accessing software.

8. The computer network access device of claim 7 wherein said accessing software in said access device comprises a dip login server program to enable a remote data device to dial-up said access device and establish communication with said access device.

9. The computer network access device of claim 7 wherein said accessing software for establishing the connection between the access device and the global computer network comprises a dip utility program to dial out through said output modem to connect to an Internet Service Provider.

10. The computer network access device of claim 7 further comprising a second input modem for providing communication with a second remote data device.
